(19) United States
(12) Patent Application Publication
(10) Pub. No.: US 2026/0267027 A1
(43) Pub. Date: Sep. 10, 2026

(54) GROUND DETECTION TECHNOLOGY FOR PIPE DAMAGE BASED ON ALTERNATING ELECTROMAGNETIC EXCITATION

(71) Applicant: Southwest Petroleum University, Chengdu (CN)

(72) Inventors: Tengjiao He, Chengdu (CN); Jiancheng Liao, Chengdu (CN); Kexi Liao, Chengdu (CN); Huaixin Zhang, Chengdu (CN); Songlin Yuan, Chengdu (CN)

(21) Appl. No.: 19/539,201

(22) Filed: Feb. 13, 2026

(30) Foreign Application Priority Data
Mar. 5, 2025 (CN) 202510254522.2

(51) Int. Cl. G01V 3/28; G01M 3/02; G01N 27/904; G01V 3/12

(52) U.S. Cl. CPC G01V 3/28; G01M 3/022; G01N 27/904; G01V 3/12

(57) ABSTRACT

Disclosed is a ground detection method for pipe damage based on alternating electromagnetic excitation, including the following steps: collecting basic information of a steel pipe, including a dimension, a burial depth, and material of the pipe; determining an excitation frequency; calibrating a basic electromagnetic signal intensity; detecting pipe damage; classifying and grading the pipe damage for identification by electromagnetic signal waveform, synergistic variation characteristics between different components, and a pipe damage degree quantitative calculation model, determining a pipe failure risk on the basis of regional gratings, and providing corresponding maintenance recommendations. A more accurate and efficient solution is provided for non-excavation ground detection of pipes.

### CROSS-REFERENCE TO RELATED APPLICATION

This application claims priority of Chinese Patent Application No. 202510254522.2, filed on Mar. 5, 2025, the entire contents of which are incorporated herein by reference.

### TECHNICAL FIELD

The disclosure relates to the technical field of safety of oil and gas pipes, and particularly relates to a ground detection technology for pipe damage based on alternating electromagnetic excitation.

### BACKGROUND

As a main way of transporting oil and gas energy, pipes have the advantages such as high transportation capacity and low operating costs, which are the lifeline for safeguarding national modern energy security. For a long-distance oil and gas pipe that is characterized by numerous points, long lines, and wide coverage, and is distributed across complex environments, damage such as stress concentration and volume loss is prone to be generated under the combined effects of internal operating pressure, temperature difference, soil loads, and media. Moreover, it is extremely prone to fracture failure under the action of internal and external loads, severely threatening safe operations of pipes, and resulting in pipe leaks, fracture failure, and substantial economy and property losses. Therefore, regular pipe detection is required to monitor the safety condition of the pipe and ensure the safe operation of the pipe.

Existing methods for monitoring pipe safety condition primarily include excavation-based detection represented by ultrasonic stress detection and non-excavation detection represented by magnetic flux leakage internal detection. The excavation-based detection has the risk of disrupting the geological structure of target pipes and triggering geological hazards. The conduction of internal detection requires pig launchers/receivers as support, and the fixed station-station detection routes fail to meet targeted detection needs for certain risk sections. Additionally, the operation of an internal detector has specific requirements for operating conditions, and the pressure-reducing throttling operations lower pipe transmission efficiency, resulting in losses of economic benefits. Non-contact magnetic testing methods have advantages such as non-excavation requirements and independence from pipe diameter and operating conditions, and have emerged as one of the primary means for buried pipe detection.

However, the geomagnetic excitation-based pipe magnetic tomography method (MTM) has the following deficiencies.

1. The detection signal intensity is low and the availability thereof is inadequate. Non-contact ground signals collected during actual detection belong to geomagnetic excitation. Under significant lift-off conditions, the signal attenuates severely in space, resulting in low intensity of the collected signal.

2. The detected signal is susceptible to environmental interference and unable to achieve quantitative damage assessment. In practical detection, there is interference from stray currents and geomagnetic field fluctuations, leading to poor repeatability between different rounds and failing to achieve quantitative assessment of pipe damage.

3. It is unable to achieve ground identification of damage types. The signal processing methods of existing detection technologies are insufficient, only achieving ground identification of the damage through signal fluctuations, and failing to establishing correlations between signals and damage types to achieve the identification of pipe damage types.

### SUMMARY

In response to the above-mentioned problems, the disclosure provides a ground detection technology for pipe damage based on alternating electromagnetic excitation. On the basis of differences in metallography and tissue structure caused by the stress at the damage location and the corrosion products, a secondary excitation generated by alternating current at the damage location is utilized to enhance the signal intensity of ground detection, achieving a breakthrough from “weak excitation and weak signal” to “strong excitation and strong signal”, thereby providing a technical support for quantitative analysis of stress of girth welds.

The technical solution provided by the disclosure to solve the above-mentioned technical problems is a ground detection technology for pipe damage based on alternating electromagnetic excitation, which includes a ground detection device and method for pipe damage based on alternating electromagnetic excitation. The ground detection method for the pipe damage based on alternating electromagnetic excitation includes the following steps:
S1. collecting basic design parameters of a pipe to be detected, determining a pipe section to be detected according to on-site requirements, and calibrating a pipe trend and a burial depth by a pipe locator, to complete preliminary work of ground detection for the pipe damage based on alternating electromagnetic excitation;
S2. detecting the pipe damage under different frequencies, and determining an optimal excitation frequency by comparing detection results of different rounds;
S3. calibrating a basic electromagnetic signal intensity of the pipe to be detected, and correcting the basic electromagnetic signal intensity by a signal correction model according to actual pipe diameter and burial depth information;
S4. connecting an alternating excitation device to a cathodic protection potential test post via a wire, applying an alternating current to the pipe at the optimal excitation frequency, and detecting pipe damage degree by an inspector wearing a wearable ground detection device for the pipe damage based on alternating electromagnetic excitation and moving in a uniform velocity along an axial direction of the pipe; and
S5. classifying and grading the pipe damage for identification on the basis of electromagnetic signal waveform, synergistic variation characteristics between different components, and a pipe damage degree quantitative calculation model, determining a pipe failure risk on the basis of regional ratings, and providing corresponding maintenance recommendations.

In an embodiment, a method for determining the optimal excitation frequency in step S2 includes the following steps:
S21. applying an excitation current to the pipe via the cathodic protection potential test post, and applying an arbitrary excitation frequency to the pipe;
S22. pre-detecting a pipe section having a potential risk along the axial direction of the pipe until an electromagnetic signal anomaly is detected, and locating pipe damage; and
S23. adjusting an alternating excitation current frequency, performing repeated detection on an identified damage location, comparing variation amplitudes of electromagnetic signals of different frequencies, and selecting an excitation frequency with a maximum variation amplitude as an optimal excitation frequency.

In an embodiment, in step 2, the electromagnetic signal is obtained by differential processing of a collected electromagnetic signal induction intensity, with the objective of eliminating the interference of a background magnetic field intensity via differentiation. The electromagnetic signal is classified into three components: Gᵢₓ, G_{iy} and G_{iz} and a modulus Gᵢ, and a calculation formula for the variation amplitude of the electromagnetic signal is expressed as:

$$Δ {G}_{i} = {G}_{i max} - {G}_{iave} \qquad ( 1 )$$

where ΔGᵢ is the variation amplitude of the electromagnetic signal, nT/m; Gᵢₘₐₓ is a collected maximum electromagnetic signal of the damage, nT/m; and Gᵢₐᵥₑ is an average value of electromagnetic signals at a non-damage location.

In an embodiment, a method for calibrating the basic electromagnetic signal intensity in step S3 includes the following steps:
S31. applying an excitation current to the pipe via the cathodic protection potential test post, with a current frequency being an optimal excitation current obtained from testing;
S32. selecting a normal pipe and girth weld for detection, acquiring variation amplitudes of electromagnetic signal components, and determining same as basic electromagnetic signal intensities for the normal pipe and girth weld; and
S33. recording burial depth and pipe diameter information of the pipe, and correcting three basic intensity components: ΔGᵢₛₜₐₓ, ΔG_{istay} and ΔG_{istaz} and a modulus ΔGᵢₛₜₐ using an electromagnetic signal height correction model.

In an embodiment, a calculation formula for the electromagnetic signal height correction model is as follows:

$${G}_{ista} = {G}_{i} / [ {f}_{1} ( D ) {e}^{- {k}_{1} h} - {f}_{2} ( D ) {e}^{- {k}_{2} h} ] \qquad ( 2 )$$

where Gᵢₛₜₐ is an electromagnetic signal intensity under a standard height condition, nT/m; Gᵢ is a collected electromagnetic signal intensity; f₁(D), f₂(D), k₁, and k₂ are undetermined parameters related to pipe burial depth and wall thickness, obtained by a burial depth testing experiment; D is a pipe diameter, m; and h is a pipe burial depth, m.

In an embodiment, a classification and grading assessment method for the pipe damage in step S5 includes the following steps:
S51. converting the electromagnetic signal intensity to the electromagnetic signal intensity under the standard height condition using the electromagnetic signal height correction model on the basis of the pipe burial depth recorded by the pipe locator during detection;
S52. achieving ground identification of pipe damage types by comparing electromagnetic signal waveform (single-peak fluctuations, and sinusoidal fluctuations) and synergistic variation characteristics between signal components (individual or a plurality of signal changes caused by different damage types) in an early stage;
S53. extracting a maximum variation value of a specific electromagnetic signal component or modulus according to the damage types, referencing an initial pipe pressure, and acquiring pipe damage degree using pipe damage degree value F calculation model that accounts for pipe stress state; and
S54. referencing the pipe damage degree and a maintenance management method to provide corresponding maintenance recommendations on the basis of pipe damage degree value F.

In an embodiment, in step S5, the pipe damage degree value F calculation model that considers the pipe stress state is as follows:

$$F = {e}^{[ 1 - f ( σ ) \frac{Δ {G}_{ista}}{Δ {G}_{ista 0}} ]} \qquad ( 3 )$$

where value F is the pipe damage degree; f(σ) is a correction coefficient considering the pipe stress state; ΔGᵢₛₜₐ is the variation value of the electromagnetic signal under the standard height condition, which can be replaced with three components ΔGᵢₛₜₐₓ, ΔG_{istay} and ΔG_{istaz} on the basis of actual damage types and actual requirements, nT/m; ΔGᵢₛₜₐ₀ is a benchmark variation value of the electromagnetic signal under the standard height condition, which can be replaced with three components ΔGᵢₛₜₐₓ, ΔG_{istay} and ΔG_{istaz} on the basis of actual damage types and actual requirements, nT/m.

In an embodiment, in step S5, the pipe damage degree and the maintenance management method are as follows:
in a case that 0.4<F<1, pipe damage degree in low- and medium-risk areas is classified as level I, which is low risk, and it is recommended that a pipe be used normally; and pipe damage degree in high-risk areas is classified as level II, which is medium risk, and it is recommended that a pipe be used under monitoring;
in a case that 0.2<F<0.4, pipe damage degree in low- and medium-risk areas is classified as level II, which is medium risk, and it is recommended that a pipe be used under monitoring; and pipe damage degree in high-risk areas is classified as level III, which is high risk, and it is recommended that a pipe be maintained immediately; and
in a case that 0<F<0.2, pipe damage degree in low-, medium-, and high-risk areas is classified as level III, which is high risk, and it is recommended that a pipe be maintained immediately.

The disclosure has the following advantageous effects.

1. The detection method provided in the disclosure, which strengthens non-contact signal intensity through alternating electromagnetic excitation current, enhances the intensity of ground-based non-contact signals via secondary excitation induced by current distortion at damage locations, thereby improving damage localization accuracy and detection rates.

2. The second-order exponential electromagnetic signal height correction model provided in the disclosure solves the problems of missed or false detection caused by abnormal signal fluctuations due to variations in pipe burial depth during detection. The intensity of the collected electromagnetic signal is corrected to the intensity under the standard height by the model, providing a basis for assessing the damage degree.

3. The disclosure provides a classification method for identifying pipe damage types based on electromagnetic signal component waveform and synergistic variation patterns, and a damage degree assessment method is established by combining the signal fluctuation amplitudes. The integration of the two achieves classified and graded assessment of damage in buried steel pipes.

4. Referencing the classified and graded damage assessment method provided in the disclosure, a pipe failure risk is assessed on the basis of damage degree and regional risk ratings, and corresponding maintenance and management measures and methods are established.

### BRIEF DESCRIPTION OF THE DRAWINGS

For clearer technical solutions of the embodiments in the disclosure, the accompanying drawings in the embodiments will be described briefly below. Obviously, the accompanying drawings described below are only some embodiments in the disclosure, and do not limit the disclosure.

FIG. 1 is a schematic diagram of a ground detection method for pipe damage based on alternating electromagnetic excitation according to the disclosure;

FIG. 2 is a schematic diagram of a device used for applying alternating electromagnetic excitation and conducting signal acquisition on a pipe according to the disclosure;

FIG. 3A shows the fluctuation of x-component of an electromagnetic signal from stress concentration damage according to the disclosure;

FIG. 3B shows the fluctuation of y-component of the electromagnetic signal from the stress concentration damage according to the disclosure;

FIG. 3C shows the fluctuation of z-component of the electromagnetic signal from the stress concentration damage according to the disclosure;

FIG. 3D shows the modulus of electromagnetic signal from the stress concentration damage according to the disclosure;

FIG. 4A shows the fluctuation of x-component of an electromagnetic signal from girth weld damage according to the disclosure;

FIG. 4B shows the fluctuation of y-component of the electromagnetic signal from the girth weld damage according to the disclosure;

FIG. 4C shows the fluctuation of z-component of the electromagnetic signal from the girth weld damage according to the disclosure; and

FIG. 4D shows the modulus of electromagnetic signal from the girth weld damage according to the disclosure.

Reference numerals and denotations thereof:
1—buried pipe, 2—magnetometric gradiometer, 3—cathodic protection post, 4—alternating excitation device, 5—connecting wire, 6—pipe covering soil, 7—RTK positioning device, 8—engineering upper computer, 9—wearable skeleton, and 10—backpack shoulder strap.

### DETAILED DESCRIPTION

For clearer objective, technical solutions and advantages of the disclosure, the technical solutions of the embodiments in the disclosure will be described clearly and completely by reference to the accompanying drawings of the embodiments in the disclosure below. Unless otherwise defined, the technical or scientific terms used in the disclosure have the ordinary meaning understood by those of ordinary skill in the art to which the disclosure belongs. In the disclosure, terms such as “comprising”, “including” or similar expressions means that the elements or objects preceding these terms include the specifically listed elements or objects following them, as well as equivalents thereof, without excluding the presence of additional elements or objects. Terms such as “upper”, “lower”, “left”, and “right” are used solely to indicate relative positional relationships. When the absolute position of the described object changes, the relative positional relationship may also change accordingly. The disclosure is further described by reference to the accompanying drawings and embodiments below.

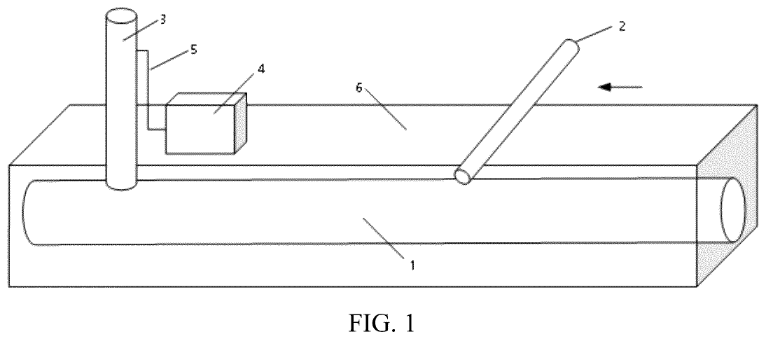

As shown in FIG. 1 to FIG. 4D, a ground detection technology for pipe damage based on alternating electromagnetic excitation includes the following steps.

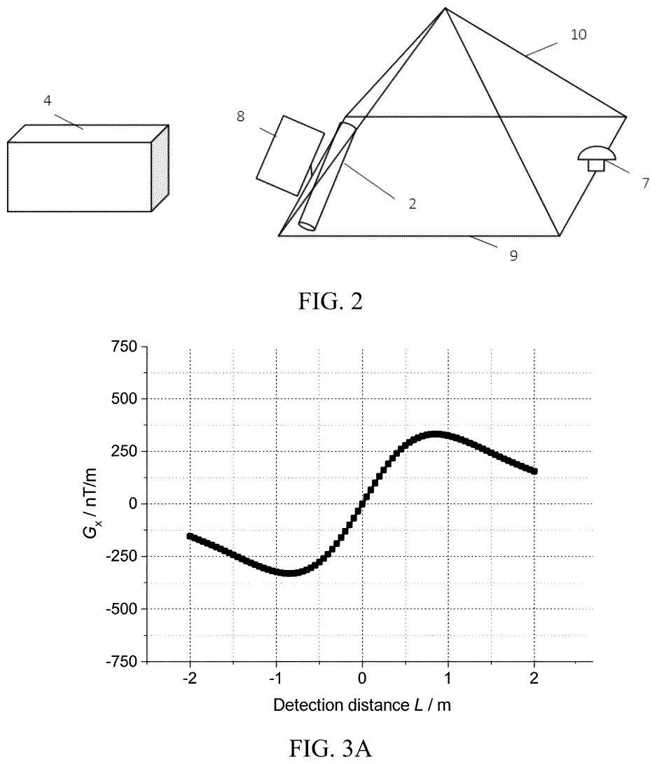

FIG. 2 shows an alternating electromagnetic excitation-based ground detection device for pipe damage, where a magnetometric gradiometer 2 is used for collecting electromagnetic signals, an RTK positioning device 7 can record the latitude and longitude information of the detection in real time, an engineering upper computer 8 achieves data synchronization of electromagnetic signals and latitude-longitude signals, and signal display and real-time storage functions, a wearable skeleton 9 and a backpack shoulder strap 10 together form a wearable frame to enable single-person detection, and an alternating excitation device 4 has the function of applying specific modulated signals to the pipe.

S1. Basic design parameters of a pipe to be detected are collected, a pipe section to be detected is determined according to on-site requirements, and a pipe trend and a burial depth are calibrated by a pipe locator, to complete preliminary work of ground detection for the pipe damage based on alternating electromagnetic excitation.

S2. As shown in FIG. 1, a cathodic protection post 3 is connected to an alternating excitation device 4 via a connecting wire 5 to apply alternating current excitation to a buried pipe 1, and a magnetometric gradiometer 2 is used to collect ground electromagnetic signals of the pipe 1. The operator holds the gradient meter 2 and travels along the axis of the pipe above the soil cover layer 6, collecting electromagnetic signals generated by damage along the line. Under different frequencies of electromagnetic excitation, the frequency with the most obvious waveform and amplitude characteristics is determined as the optimal excitation frequency.

A method for determining the optimal excitation frequency includes the following steps.

S21. An excitation current is applied to the pipe via a cathodic protection potential test post, and an arbitrary excitation frequency is applied to the pipe.

S22. A pipe section having a potential risk is pre-detected along an axial direction of the pipe until an electromagnetic signal anomaly is detected, and pipe damage is located.

S23. An alternating excitation current frequency is adjusted, repeated detection is performed on an identified damage location, variation amplitudes of electromagnetic signals of different frequencies are compared, and an excitation frequency with a maximum variation amplitude is selected as an optimal frequency. It is found by comparative tests that the optimal excitation frequency for a pipe of 1016 mm×80 is 62.1 kHz.

In step 2, the electromagnetic signal is obtained by differential processing of a collected electromagnetic signal induction intensity, with the objective of eliminating the interference of a background magnetic field intensity via differentiation. The electromagnetic signal is classified into three components: Gᵢₓ, G_{iy} and G_{iz} and a modulus Gᵢ, and a calculation formula for the variation amplitude of the electromagnetic signal is expressed as:

$$Δ {G}_{i} = {G}_{i max} - {G}_{iave} \qquad ( 4 )$$

where ΔGᵢ is the variation amplitude of the electromagnetic signal, nT/m; Gᵢₘₐₓ is a collected maximum electromagnetic signal of the damage, nT/m; and Gᵢₐᵥₑ is an average value of electromagnetic signals at a non-damage location.

S3. A basic electromagnetic signal intensity of the pipe to be detected is calibrated, with a diameter of a target pipe section being 1016 mm. The basic electromagnetic signal intensity is corrected by a signal correction model.

A method for calibrating the basic electromagnetic signal intensity includes the following steps.

S31. An excitation current is applied to the pipe via the cathodic protection potential test post, with a current frequency being an optimal excitation current obtained from testing.

S32. A normal pipe and girth weld are selected for detection, variation amplitudes of electromagnetic signal components are acquired, and same are determined as basic electromagnetic signal intensities for the normal pipe and girth weld.

S33. Burial depth and diameter information of the pipe are recorded, and three basic intensity components ΔGᵢₛₜₐₓ, ΔG_{istay} and ΔG_{istaz} and a modulus ΔGᵢₛₜₐ are corrected using an electromagnetic signal height correction model.

A calculation formula for the electromagnetic signal height correction model is as follows:

$${G}_{ista} = {G}_{i} / [ 1.489 {e}^{- 5.01 h} + 0.122 {e}^{- 1.1429 h} ] \qquad ( 5 )$$

where Gᵢₛₜₐ is an electromagnetic signal intensity under a standard height condition, nT/m; Gᵢ is a collected electromagnetic signal intensity; f₁(D), f₂(D), k₁, and k₂ are undetermined parameters related to pipe burial depth and wall thickness, obtained by a burial depth testing experiment; D is a pipe diameter, m; and h is a pipe burial depth, m.

S4. An alternating excitation device is connected to a cathodic protection potential test post via a wire, an alternating current is applied to the pipe at the optimal excitation frequency, and pipe damage degree is detected by an inspector wearing a wearable ground detection device for the pipe damage based on alternating electromagnetic excitation and moving in a uniform velocity along an axial direction of the pipe, with the wearable detection device as shown in FIG. 2.

S5. The pipe damage is classified and graded for identification on the basis of electromagnetic signal waveform, synergistic variation characteristics between different components, and a pipe damage degree quantitative calculation model, a pipe failure risk is determined on the basis of regional ratings, and corresponding maintenance recommendations are provided.

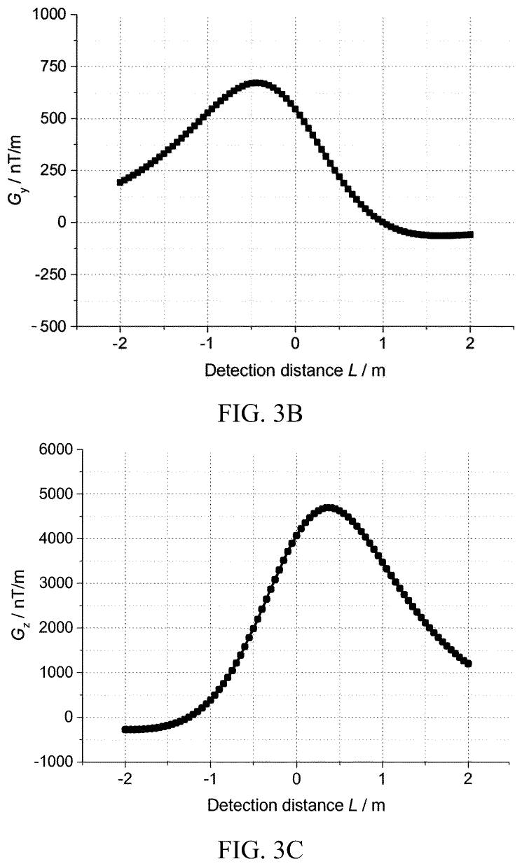

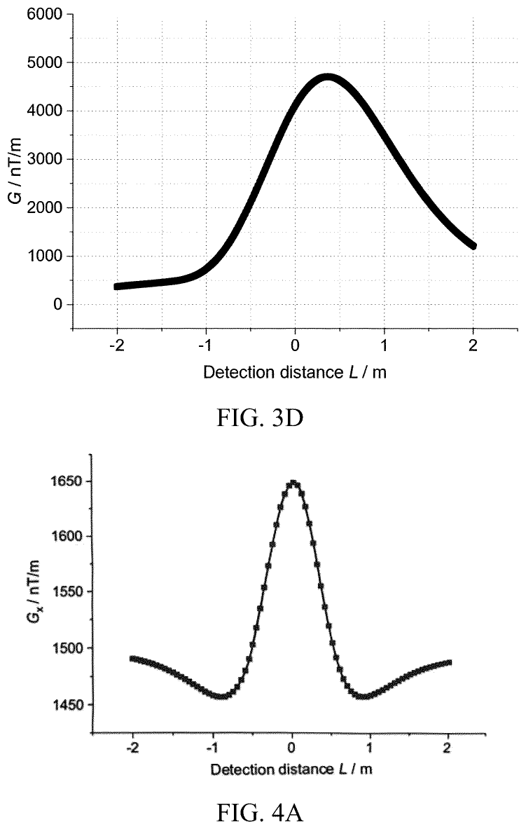

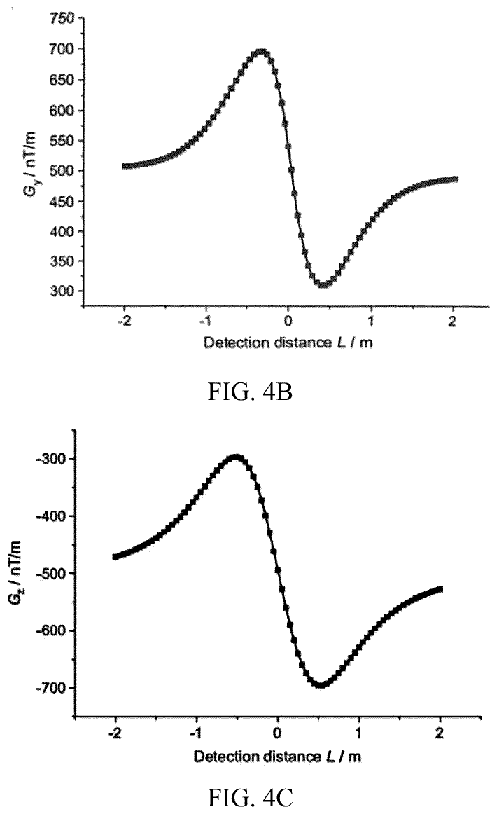

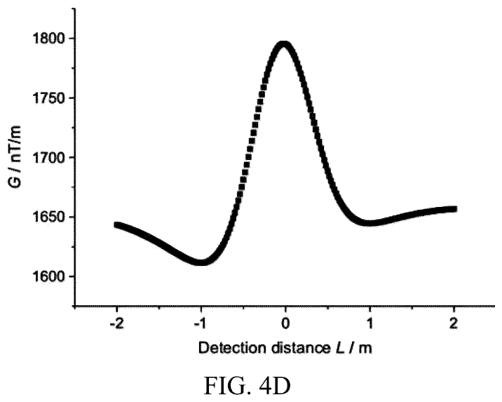

S51. On the basis of the pipe burial depth recorded by the pipe locator during detection, two damages are detected, and the electromagnetic signal intensity is converted to the electromagnetic signal intensity under the standard height condition using the electromagnetic signal height correction model, with the corrected signal as shown in FIGS. 3A-3D and FIGS. 4A-4D.

S52. As shown in FIGS. 3A-3D, the z-component of the electromagnetic signal exhibits a single-peak fluctuation, x- and y-components exhibit sinusoidal fluctuation, and z-signal exhibits asymmetry. Therefore, the damage is stress concentration damage. As shown in FIGS. 4A-4D, the y- and z-components of the electromagnetic signal exhibit sinusoidal fluctuation, x-signal exhibits Ω-shaped characteristics, and therefore this damage is a metal loss.

S53. A maximum variation value of a specific electromagnetic signal component or modulus is extracted according to the damage types, an initial pipe pressure is referenced, and pipe damage degree is acquired using pipe damage degree value F calculation model that considers pipe stress state.

S54. In accordance with the pipe damage degree and a maintenance management method, corresponding maintenance recommendations are provided on the basis of pipe damage degree value F. For pipes having stress concentration, the z-component of the electromagnetic signal is used to assess the pipe damage degree; and for pipes having metal loss, the x-component of the electromagnetic signal is used to assess the pipe damage degree.

The stress concentration pipe damage assessment model is as shown in formula (6):

$$F = {e}^{[ 1 - 0.73 \frac{Δ {G}_{istaz}}{2000} ]} 0.27 \qquad ( 6 )$$

where the variation value of the electromagnetic signal ΔG_{istaz} is z-component of the electromagnetic signal, nT/m.

The metal loss pipe damage assessment model is as shown in formula (7):

$$F = {e}^{[ 1 - 0.9 \frac{Δ {G}_{istax}}{130} ]} 0.55 \qquad ( 7 )$$

where the variation value of the electromagnetic signal ΔGᵢₛₜₐₓ is x-component of the electromagnetic signal, nT/m.

The variation of ΔG_{istaz} in FIG. 3C is 4787 nT. Therefore, the calculated value F is 0.27. The variation of ΔGᵢₛₜₐᵣ in FIG. 4A is 230 nT, and the calculated value F is 0.55.

The pipe damage degree and the maintenance management method are as follows.

In a case that 0.4<F<1, pipe damage degree in low- and medium-risk areas is classified as level I, which is low risk, and it is recommended that a pipe be used normally; and pipe damage degree in high-risk areas is classified as level II, which is medium risk, and it is recommended that a pipe be used under monitoring.

In a case that 0.2<F<0.4, pipe damage degree in low- and medium-risk areas is classified as level II, which is medium risk, and it is recommended that a pipe be used under monitoring; and pipe damage degree in high-risk areas is classified as level III, which is high risk, and it is recommended that a pipe be maintained immediately.

In a case that 0<F<0.2, pipe damage degree in low-, medium- and high-risk areas is classified as level III, which is high risk, and it is recommended that a pipe be maintained immediately.

According to the described pipe damage degree grading criteria, pipe sections having stress concentration are located in high-risk areas, which have the value F ranging between 0.2 and 0.4, and the risk assessment result of high risk, and it is recommended that immediate maintenance be required; and pipes having metal loss are located in medium-risk areas, which have the value F ranging between 0.4 and 1, and the risk assessment result of low risk, and it is recommended that the pipes be used normally.

The above-mentioned content is merely preferred embodiments of the disclosure and is not intended to limit the disclosure in any form. Although the disclosure is disclosed through the preferred embodiments, the embodiments are not used to limit the disclosure. Any skilled familiar with the art can, without departing from the technical solutions of the disclosure, make some modifications or adaptations to the disclosed technical content to form equivalent embodiments of equivalent changes. All modifications, equivalent variations, and adaptations made to the above-mentioned embodiment based on the technical essence of the disclosure, which do not deviate from the scope of the technical solution of the disclosure, remain within the scope of the technical solutions of the disclosure.

1. A ground detection method for pipe damage based on alternating electromagnetic excitation, comprising the following steps:
S1. collecting basic design parameters of a pipe to be detected, determining a pipe section to be detected according to on-site requirements, and calibrating a pipe trend and a burial depth by a pipe locator, to complete preliminary work of ground detection for pipe damage based on alternating electromagnetic excitation;
S2. detecting the pipe damage under different frequencies, and determining an optimal excitation frequency by comparing detection results of different rounds;
S3. calibrating a basic electromagnetic signal intensity of the pipe to be detected, and correcting the basic electromagnetic signal intensity by a signal correction model according to actual pipe diameter and burial depth information;
step S3 comprising the following steps:
S31. applying an excitation current to the pipe via a cathodic protection potential test post, with a current frequency being an optimal excitation current obtained from testing;
S32. selecting a normal pipe and girth weld for detection, acquiring variation amplitudes of electromagnetic signal components, and determining same as basic electromagnetic signal intensities for the normal pipe and girth weld; and
S33. recording burial depth and diameter information of the pipe, and correcting three basic intensity components ΔGᵢₛₜₐₓ, ΔG_{istay}, ΔG_{istaz} and a modulus ΔGᵢₛₜₐ using an electromagnetic signal height correction model;
a calculation formula for the electromagnetic signal height correction model being as follows:
$${G}_{ista} = {G}_{i} / [ {f}_{1} ( D ) {e}^{- {k}_{1} h} + {f}_{2} ( D ) {e}^{- {k}_{2} h} ] \qquad ( 1 )$$
where Gᵢₛₜₐ is an electromagnetic signal intensity under a standard height condition, nT/m; Gᵢ is a collected electromagnetic signal intensity; f₁(D), f₂(D), k₁, and k₂ are undetermined parameters related to pipe burial depth and wall thickness, obtained by a burial depth testing experiment; D is a pipe diameter, m; and h is a pipe burial depth, m;
S4. connecting an alternating excitation device to the cathodic protection potential test post via a wire, applying an alternating current to the pipe at the optimal excitation frequency, and detecting pipe damage degree by an inspector wearing a wearable ground detection device for the pipe damage based on alternating electromagnetic excitation and moving in a uniform velocity along an axial direction of the pipe; and
S5. classifying and grading the pipe damage for identification on the basis of electromagnetic signal waveform, synergistic variation characteristics between different components, and a pipe damage degree quantitative calculation model, determining a pipe failure risk on the basis of regional ratings, and providing corresponding maintenance recommendations;
step S5 comprising the following steps:
S51. converting the electromagnetic signal intensity to the electromagnetic signal intensity under the standard height condition using the electromagnetic signal height correction model on the basis of the pipe burial depth recorded by the pipe locator during detection;
S52. achieving ground identification of pipe damage types by comparing electromagnetic signal waveform and synergistic variation characteristics between signal components in an early stage;
S53. extracting a maximum variation value of a specific electromagnetic signal component or modulus according to the damage types, referencing an initial pipe pressure, and acquiring the pipe damage degree using a pipe damage degree value F calculation model that considers pipe stress state; and
S54. referencing the pipe damage degree and a maintenance management method to provide corresponding maintenance recommendations on the basis of pipe damage degree value F;
in step S5, the pipe damage degree value F calculation model being as follows:
$$F = {e}^{[ 1 - f ( σ ) \frac{Δ {G}_{ista}}{Δ {G}_{ista 0}} ]} \qquad ( 2 )$$
where value F is the pipe damage degree; f(σ) is a correction coefficient considering the pipe stress state; ΔGᵢₛₜₐ is a variation value of the electromagnetic signal under the standard height condition, which can be replaced with three components ΔGᵢₛₜₐₓ, ΔG_{istay} and ΔG_{istaz} of the variation value of the electromagnetic signal on the basis of actual damage types and actual requirements, nT/m; and ΔGᵢₛₜₐ₀ is a benchmark variation value of the electromagnetic signal under the standard height condition, which can be replaced with three components ΔGᵢₛₜₐ₀ₓ, Δ_{Gista0y} and ΔG_{ista0z} of the benchmark variation value of the electromagnetic signal on the basis of actual damage types and actual requirements, nT/m.

2. The ground detection method for pipe damage based on alternating electromagnetic excitation according to claim 1, wherein step S2 comprises the following features:
S21. applying an excitation current to the pipe via the cathodic protection potential test post, and applying an arbitrary excitation frequency to the pipe;
S22. pre-detecting a pipe section having a potential risk along the axial direction of the pipe until an electromagnetic signal anomaly is detected, and locating the pipe damage; and
S23. adjusting an alternating excitation current frequency, performing repeated detection on an identified damage location, comparing variation amplitudes of electromagnetic signals of different frequencies, and selecting an excitation frequency with a maximum variation amplitude as an optimal excitation frequency; and
in step 2, the electromagnetic signal is obtained by differential processing of a collected electromagnetic signal induction intensity, with the objective of eliminating the interference of a background magnetic field intensity via differentiation, wherein the electromagnetic signal is classified into three components: Gᵢₓ, G_{iy} and G_{iz} and a modulus Gᵢ, and a calculation formula for the variation amplitude of the electromagnetic signal is expressed as:
$$Δ {G}_{i} = {G}_{i max} - {G}_{iave} \qquad ( 3 )$$
where ΔGᵢ is the variation amplitude of the electromagnetic signal, nT/m; Gᵢₘₐₓ is a collected maximum electromagnetic signal of the damage, nT/m; and Gᵢₐᵥₑ is an average value of electromagnetic signals at a non-damage location.

3. The ground detection method for pipe damage based on alternating electromagnetic excitation according to claim 1, wherein in step S5, the pipe damage degree and the maintenance management method are as follows:
in a case that 0.4<F<1, pipe damage degree in low- and medium-risk areas is classified as level I, which is low risk, and it is recommended that a pipe be used normally; and pipe damage degree in high-risk areas is classified as level II, which is medium risk, and it is recommended that a pipe be used under monitoring;
in a case that 0.2<F<0.4, pipe damage degree in low- and medium-risk areas is classified as level II, which is medium risk, and it is recommended that a pipe be used under monitoring; and pipe damage degree in high-risk areas is classified as level III, which is high risk, and it is recommended that a pipe be maintained immediately; and
in a case that 0<F<0.2, pipe damage degree in low-, medium-, and high-risk areas is classified as level III, which is high risk, and it is recommended that a pipe be maintained immediately.
